(19) United States
(12) Patent Application Publication
(10) Pub. No.: US 2010/0093324 A1
(43) Pub. Date: Apr. 15, 2010

(54) Subscription Based Content Discovery

(75) Inventors: Vikram Makam Gupta, Cary, NC (US); Paul H. Nichols, Raleigh, NC (US); Jacob Warren Kimbrell, Raleigh, NC (US); Jeffrey J. Griffin, Harrisburg, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/251,932

(22) Filed: Oct. 15, 2008

(51) Int. Cl. H04W 4/06

(52) U.S. Cl. 455/414.2; 455/418

(57) ABSTRACT

Mobile phone users can subscribe to a notification for new content by creating a profile of user preferences on the operator or manufacturer's website on a server. When new content matching the profile becomes available, the server will send to the mobile phone a WAP push message containing a link to the content. The user can access and download the new content by pressing a dedicated key on the mobile phone and following the link in the WAP push message.

### BACKGROUND

The present disclosure relates to mobile phones, more particularly to locating user preferred content for mobile phones.

Few techniques are currently available to mobile phone users to locate and select, online, content such as wallpapers, screensavers, ringtones, games, utility applications, and the like. These techniques often fail to thoroughly satisfy users and can require heavy usage of a personal computer (PC). It is a challenge to the phone provider to direct a user to appropriate content to boost content sales and increase data traffic.

One current technique is to preset a key or provide a shortcut on a desktop to take the user directly to the operator's or the manufacturer's website. The user gains easy access to the website, but must navigate the website, entering and exiting several sections of the portal, before locating desired content. Among disadvantages of this approach are the possibility of a slow data connection, inconvenience of the small phone screen, investment of time and effort by the user, and a lack of review of the content available. This technique also requires the user to periodically visit the website. If the user is not satisfied with the content during one visit to the website, he might be discouraged from using the portal again.

Alternatively, a PC-based web browser can be used to locate content on the Internet. There are several manufacturer, operator, and third-party websites that sell content online. Users pay a recurring or a per-download fee to download the content. Content can either be downloaded to the computer and then transferred to the phone, or can be directly downloaded to the phone by following appropriate URLs. While this technique may be more convenient, it nevertheless requires a PC to do the searching and does not benefit from spontaneity of the user to download by phone. This technique neither helps in generating more data traffic for the phone service provider nor does it boost operator/manufacturer content sales, as the user is not discouraged from pulling, possibly cheaper, content from an unknown third-party source. This technique may also pose a security hazard to the mobile handset and its user.

Some of the most popular methods result in loss of business for the manufacturer and/or operator and in lower user satisfaction. The need thus exists for an improved method of providing a mobile phone user with preferred content.

### DISCLOSURE

The above described needs are fulfilled, at least in part, by providing a subscription service whereby a mobile phone subscriber can receive notifications of new content available at a server for a mobile phone. Notifications are transmitted by the service provider to the subscribing phone. A user profile can be developed by the user by selecting one or more types of content from a plurality of listed content types. Content types may include, for example, wallpapers, ringtones, games, and videos. For each selected type of content, selection from a set of qualifiers can further define the content service. The set of qualifiers may include, for example, price range, rating, theme, author, genre, required data connection, release date, and size.

The service provider can notify the user of new content by sending to the user's mobile phone a wireless application protocol push message including a link to the new content. The service provider may also create a desktop icon on the user's mobile phone to remind the user of the new content. There may be a different icon for each type of content, which may be customized by the user.

The mobile phone may include a key for accessing the manufacturer or operator's website and also a dedicated key for accessing the link to the new content. The user may be given an opportunity to rate new content and provide the rating to the service provider's server. Ratings can be stored in a rating database at the server. The server may automatically download trial content to the user's mobile phone, particularly during periods of low network use.

Still other aspects, features, and advantages will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 is a block diagram of a system for providing preferred content to a user according to an exemplary embodiment;

FIG. 2 is an illustrative view of structure of a mobile phone according to an exemplary embodiment;

FIG. 3 is a block diagram of a mobile phone;

FIG. 4 is a representation of a user profile according to an exemplary embodiment;

FIG. 5 is a representation of a user profile according to another exemplary embodiment;

FIG. 6 is a flowchart of a method of providing preferred content to a user according to an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments.

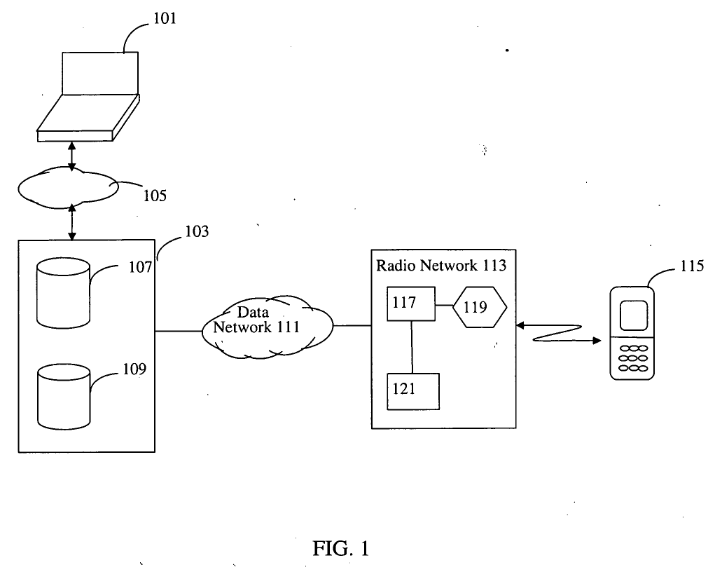

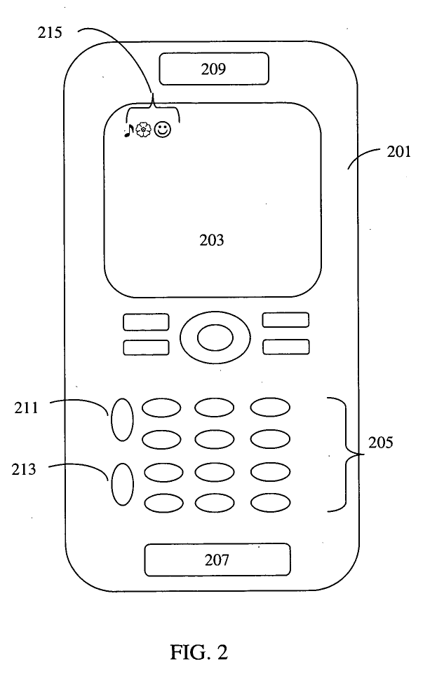

Referring to FIG. 1, personal computer (PC) 101 is coupled to server 103 via Internet 105. Server 103 contains profile database 107 and rating database 109 and may be coupled via data network 111 and radio network 113 for wireless access by mobile phone 115. Radio network 113 may comprise a cellular network for communication with mobile phone 115. In well known manner, the cellular network includes a plurality of mobile switching centers and base stations having landline connections. The illustrated mobile switching center 117 is a gateway to the data network 111. The illustrated base station subsystem 119 is located within radio range of the mobile phone 115. A short messaging system (SMS) server 121 is coupled to the mobile switching center and is accessible to server 103 via DNS address lookup. Details of mobile phone 115 will be more fully described with respect to FIG. 2.

PC 101 is employed by a mobile phone user to subscribe to information and updates on content on the operator or manufacturer website, for example, the official PC-based Sony Ericsson website (SEMC website). The user enters user preferences as to desired content at PC 101. The preferences are stored as a user profile in profile database 107 maintained on the operator or manufacturer website on server 103. When new content becomes available at server 103, the server checks the user profile for a match. If the type of new content matches the user's preferences, the server sends a notification via data network 111 and radio network 113 to the user's mobile phone 115.

Data network 111 may comprise any local area network (LAN), metropolitan area network (MAN), wide area network (WAN), the Internet, or any other suitable packet-switched network, such as a commercially owned, proprietary packet-switched network, e.g., a proprietary cable or fiber-optic network.

Radio network 113 may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Short messaging system (SMS) server 121 of radio network 113 allows server 103 to deliver notification of new content to mobile phone 115 via a simple wireless application protocol (WAP) push message.

Mobile phone 115 may include a WAP browser, which provides all of the basic services of a computer based web browser but simplified to operate within the restrictions of a mobile phone, such as its smaller view screen. The WAP push from server 103 is a specially encoded message which includes a link to a WAP address at server 103. The WAP push may be delivered over the mobile phone's SMS.

As shown in FIG. 2, mobile phone 115 may be provided in any suitable housing (or casing) 201, such as a fold (or clamshell) housing, slide housing, or swivel housing. Mobile phone 115 includes display 203, keypad 205, microphone 207, and speaker 209. Keypad 205 may include dedicated key 211 and web browser launch key 213. Display 203 may include notification icons 215.

On receiving a WAP push, mobile phone 115 will automatically give the user the option to access the WAP content. The link to the WAP content may appear on display screen 203. The link may be accessed by the user via dedicated key 211 or a key sequence. Dedicated key 211 differs from web browser launch key 213 for accessing server 103. Using dedicated key 211, or the key sequence, to follow the URL in the push, the user is directed straight to the page where he downloads either a trial or the full version of the new content.

While this notification method is simple, the push message may get buried in the user's inbox if the user does not react to it immediately. Therefore, an indicator would be beneficial to remind the user. For example, notification icons 215 on display 203 would be a constant but unobtrusive reminder of the WAP push message. As long as the icons exist, the user may depress dedicated key 211, or the key sequence, to visit the appropriate page. The user can dismiss the icons forever or have them reappear after a snooze interval. The ability to place a user just a click away from buying and/or creating data traffic is a provision of significant benefit to service providers.

If a new notification arrives before the user deals with the old one, he can have the phone either cycle through all of the notification icons, continue displaying the old, or display only the new. Different icons can be used to signify wallpapers, ringtones, videos, etc. For example, as shown if FIG. 2, a musical note might indicate a new ringtone, a flower might signify new wallpaper, and a smiley face might indicate a new game. Alternatively, the content provider may create his own icon to go with his content.

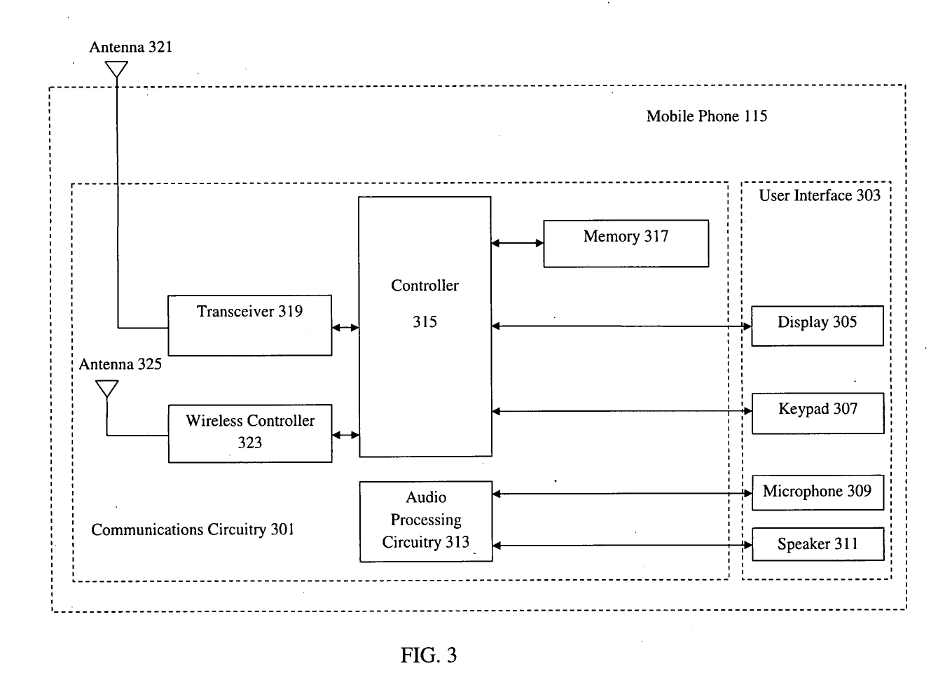

FIG. 3 is exemplary of mobile phone 115. As shown, mobile phone 115 may include communications circuitry 301, and user interface 303. While specific reference will be made thereto, it is contemplated that mobile phone 115 may embody many forms and include multiple and/or alternative components.

User interface 303 includes display 305, keypad 307, microphone 309, and speaker 311. Display 305 provides a graphical interface that permits a user of mobile phone 100 to view call status, configurable features, contact information, dialed digits, directory addresses, menu options, operating states, time, and other service information, scheduling information (e.g., date and time parameters), etc. The graphical interface may include icons and menus, as well as other text, soft controls, and symbols. In this manner, display 305 enables users to perceive and interact with the various features of mobile phone 115.

Microphone 309 converts spoken utterances of a user into electronic audio signals, while speaker 311 converts audio signals into audible sounds. Microphone 309 and speaker 311 may operate as parts of a voice (or speech) recognition system.

Keypad 307 may be a conventional input mechanism. That is, keypad 307 may provide for a variety of user input operations. For example, keypad 307 may include alphanumeric keys for permitting entry of alphanumeric information, such as contact information, directory addresses, phone lists, notes, etc. Various portions of keypad 307 may be utilized for different functions of mobile phone 115, such as for conducting voice communications, SMS messaging, MMS messaging, etc. Keypad 307 may include a “send” key for initiating or answering received communication sessions, and an “end” key for ending or terminating communication sessions. Special function keys may also include web browser launch key 213, dedicated key 211 for linking to new content, or menu navigation keys, for example, for navigating through one or more menus presented via display 305, to select different mobile communication device functions, profiles, settings, etc. Other keys associated with mobile phone 115 may include a volume key, an audio mute key, an on/off power key, etc.

In accordance with the present disclosure, keypad 307 includes web browser launch key 213 and dedicated key 211, as shown in FIG. 2. The particular locations of web browser launch key 213 and dedicated key 211 are not fixed and could be anywhere on the keypad or alternatively on the housing.

Communications circuitry 301 enables mobile phone 115 to initiate, receive, process, and terminate various forms of communications, such as voice communications (e.g., phone calls), SMS messages (e.g., text and picture messages), and MMS messages. In other instances, communications circuitry 301 enables mobile phone 115 to transmit, receive, and process data, such as endtones, image files, video files, audio files, ringbacks, ringtones, streaming audio, streaming video, etc. As such, communications circuitry 301 includes audio processing circuitry 313, controller (or processor) 315, memory 317, transceiver 319 coupled to antenna 321, and wireless controller 323 (e.g., a short range transceiver) coupled to antenna 325.

Wireless controller 323 acts as a local wireless interface, such as an infrared transceiver and/or a radio frequency adaptor (e.g., Bluetooth adapter), for establishing communication with an accessory, hands-free adapter, another mobile communication device, computer, or other suitable device or network.

Processing communication sessions may include storing and retrieving data from memory 317, executing applications to allow user interaction with data, displaying video and/or image content associated with data, broadcasting audio sounds associated with data, and the like. Accordingly, memory 317 may represent a hierarchy of memory, which may include both random access memory (RAM) and read-only memory (ROM). Computer program instructions, such as “automatic physical configuration” application instructions, and corresponding data for operation, can be stored in non-volatile memory, such as erasable programmable read-only memory (EPROM), electrically erasable programmable read-only memory (EEPROM), and/or flash memory; however, may be stored in other types or forms of storage. Memory 317 may be implemented as one or more discrete devices, stacked devices, or integrated with controller 315. Memory 317 may store program information, such as one or more user profiles, one or more user defined policies, one or more triggering events, one or more physical configurations, scheduling information, etc. In addition, system software, specific device applications, program instructions, program information, or parts thereof, may be temporarily loaded to memory 317, such as to a volatile storage device, e.g., RAM. Communication signals received by mobile phone 115 may also be stored to memory 317, such as to a volatile storage device.

Controller 315 controls operation of mobile phone 115 according to programs and/or data stored to memory 315. Control functions may be implemented in a single controller (or processor) or via multiple controllers (or processors). Suitable controllers may include, for example, both general purpose and special purpose controllers, as well as digital signal processors, local oscillators, microprocessors, and the like. Controller 315 may also be implemented as a field programmable gate array (FPGA) controller, reduced instruction set computer (RISC) processor, etc. Controller 315 may interface with audio processing circuitry 313, which provides basic analog output signals to speaker 311 and receives analog audio inputs from microphone 309.

Controller 315, in addition to orchestrating various operating system functions, also enables execution of software applications. For example, mobile phone 115 may be programmed to run a small automated script (or a Java application) every time the user downloads content. The script displays a simple feedback form for the user to rate the downloaded content. The information entered is propagated to server 103 and stored in rating or feedback database 109. The consolidated feedback is provided to other users as a content rating. The script may also include an option to forego rating the downloaded content.

Mobile phone 115 may also be equipped with a module that automatically downloads trial content from the manufacturer or operator website. The download may be initiated during the night when the network loads are low. Trial downloads will increase data traffic for the operator and increase the chance of users buying the full versions. The module is run in a low priority process to obviate any security risks. Waking up every morning to trial games automatically downloaded and installed and waiting to be played may appeal to many users.

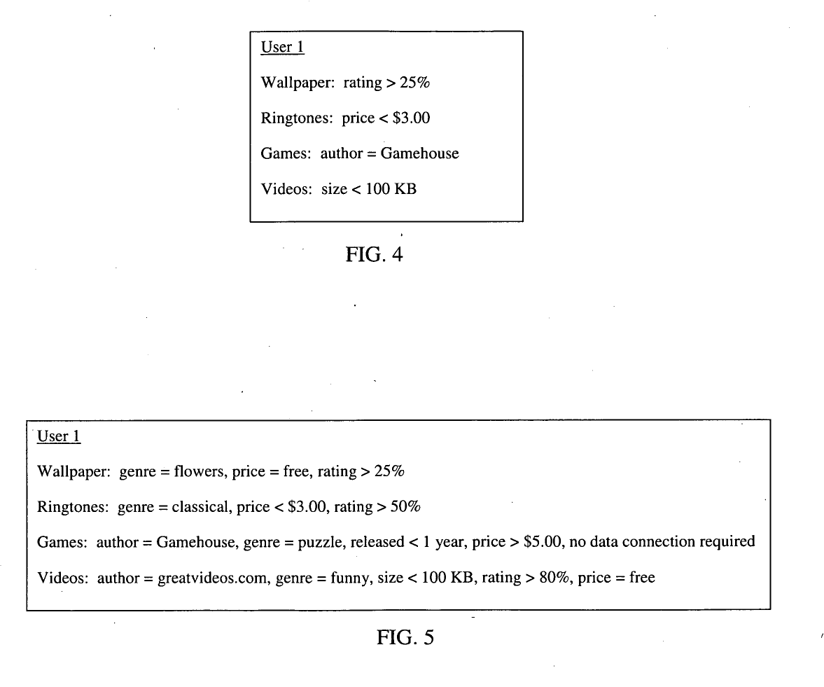

FIG. 4 illustrates an exemplary simple user profile. According to the user profile of FIG. 4, user 1 prefers wallpapers with a rating greater than 25 percent (or with more than one out of four stars), ringtones that cost less than $3.00, games by Gamehouse, and videos that are less than 100 KB. The simple profile shows each type of content sought by the user and a single qualifier for each. The types of content shown in the profile of FIG. 4 are meant to be exemplary and not exclusive. Qualifiers for the different types of content may include, but are not limited to, genre, price, rating, size, author, release date, and whether or not a data connection is required.

FIG. 5 represents an exemplary comprehensive user profile. As indicated, user 1 prefers wallpapers that not only have a rating greater than 25 percent (as in the simple profile of FIG. 4), but also cost nothing and are floral. Similarly, user 1 prefers ringtones that not only cost under $3.00 but also play classical music and have a rating greater than 50%. The user may choose the level of complexity for his profile. Although the profile shown in FIG. 5 includes three qualifiers for wallpaper and for ringtones and five for games and for videos, the user may choose how many qualifiers to specify for each type of content. On the one hand, configuring a simple set as shown in FIG. 4 may be quick and easy and, on the other hand, a more comprehensive set as shown in FIG. 5 may allow the user to fine tune his search, making the system more intelligent so that it will return better matches. The manufacturer or operator website may “learn” from the user profiles and license more content targeting user preferences. For example, if users tend to prefer games by Gamehouse, the manufacturer or operator will license more games by Gamehouse to supply to its clients.

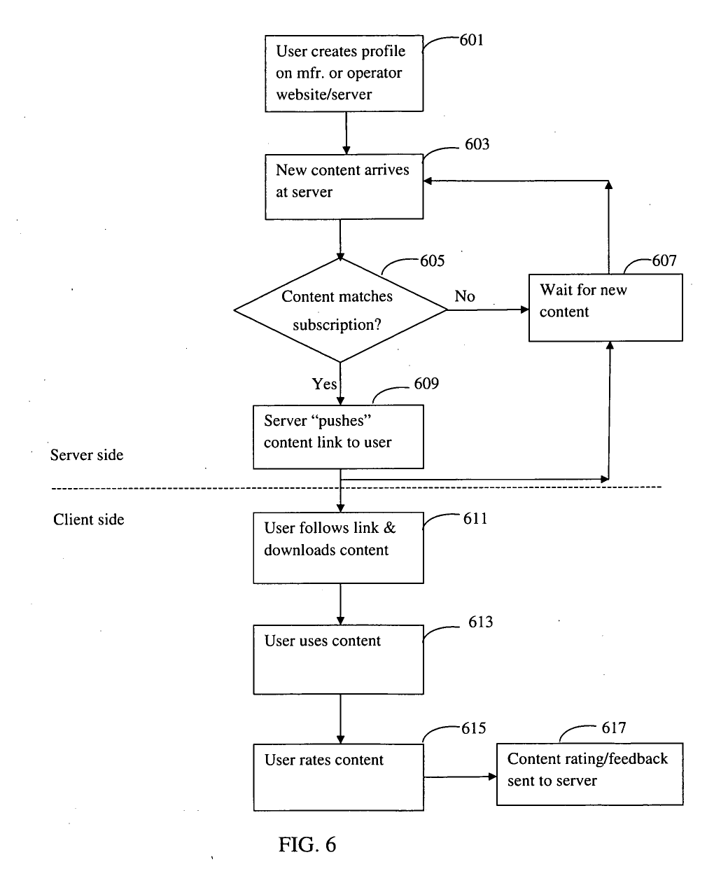

FIG. 6 is a flowchart depicting the overall method of providing preferred content to a user according to an exemplary embodiment. Steps 601 through 609 occur on the server and steps 611 through 617 occur on the client (or user's mobile phone). The process begins at step 601 where a user subscribes to a new content notification by creating a profile on the manufacturer or operator's website on server 103. The profile is stored in profile database 107 maintained on the website. When new content arrives at the server at step 603, the server at step 605 checks whether the subscription in profile database 107 matches the new content. If the new content fails to match the user profile, the server waits for further new content at step 607. If, on the other hand, the content does match the preferences in the user's profile, the server pushes the content link to the user's mobile phone (step 609).

The user, at step 611, follows the link to the content by depressing a dedicated key or sequence of keys on the mobile phone and, if the content is acceptable, downloads the content. Since the content matches the user's preferences, the user generally will download the new content. At step 613, the user uses the new content. An automated script (or a Java application) is run by the mobile phone for the user to rate the content at step 615. The user's rating is sent to the server at step 617 and stored in rating or feedback database 109. The consolidated feedback is used by the server to determine content ratings. These ratings may then be used to determine if the content meets other users' preferences. Further, the ratings may be used by the operator or manufacturer to determine what types of content users prefer in order to license and provide to users content that better targets user choices.

By subscribing to new content notifications, users can obtain new content as soon as it becomes available and need not spend significant time and effort searching for content. By tracking user preferences, operators and/or manufacturers can license more targeted content, thereby reducing the need for users to look elsewhere such as a third party source. This not only boosts business for the operator or manufacturer, but also provides more secure content to the user.

In this disclosure there are shown and described only preferred embodiments and but a few examples of its versatility. It is to be understood that the disclosure is capable of use in various other combinations and environments and is capable of changes or modifications within the scope of the inventive concept as expressed herein.

What is claimed is:

1. A method comprising:
subscribing to a server for notifications of new content available for a mobile phone, and
transmitting notification of available new content to the subscriber's mobile phone.

2. A method as recited in claim 1, wherein the step of subscribing comprises:
creating a user profile of desired content.

3. A method as recited in claim 2, wherein the step of creating a user profile comprises:
selecting one or more types of content from a plurality of listed content types.

4. A method as recited in claim 3, wherein the listed content types comprise wallpaper, ringtone, game, and video.

5. A method as recited in claim 3, wherein the step of selecting further comprises:
selecting for each selected type of content one or more qualifiers from a set of qualifiers.

6. A method as recited in claim 5, wherein the set of qualifiers comprises price range, rating, theme, author, genre, required data connection, release date, and size.

7. A method as recited in claim 1, wherein the step of transmitting comprises sending a wireless application protocol push message that includes a link to new content to the subscriber's mobile phone.

8. A method as recited in claim 1, further comprising displaying a desktop icon for each type of new content on the subscriber's mobile phone.

9. A method as recited in claim 8, further comprising a step of customizing the icons for specific content.

10. A method as recited in claim 1, further comprising activating a dedicated key on the mobile phone to access the new content.

11. A method as recited in claim 10, further comprising the steps of:
rating the new content by the subscriber, and
providing results of the rating step to the server.

12. A method as recited in claim 1, further comprising automatically downloading trial content to the subscriber's mobile phone.

13. A system comprising:
a mobile phone, and
a content server,
wherein the server is configured to send a link for new content to the mobile phone if the mobile phone is identified as a subscriber to the content server.

14. A system as recited in claim 13, wherein the server comprises a profile database.

15. A system as recited in claim 14, wherein the profile database comprises a profile of the subscriber's preferences for content for the mobile phone.

16. A system as recited in claim 15, wherein the link matches the subscriber's preferences in the profile.

17. A system as recited in claim 15, further comprising a personal computer for entering the subscriber's preferences into the profile.

18. A system as recited in claim 13, wherein the server comprises a rating database of subscribers' ratings of new content.

19. A system as recited in claim 13, wherein the mobile phone comprises a key for accessing the server and a separate key for accessing the link.

20. A system as recited in claim 13, wherein the mobile phone comprises one or more icons for notifying the user that said new content is available.
